(19) United States
(12) Patent Application Publication
(10) Pub. No.: US 2017/0037944 A1
(43) Pub. Date: Feb. 9, 2017

(54) LEAD SCREW DRIVE WITH ASYMMETRICAL INTERNAL AND EXTERNAL THREAD AND CORRESPONDING SPINDLE NUT

(71) Applicant: igus GmbH, Koln (DE)

(72) Inventors: Marco JAEKEL, Bergisch Gladbach (DE); Stefan NIERMANN, Koeln (DE)

(21) Appl. No.: 15/302,853

(22) PCT Filed: Apr. 7, 2014
(86) PCT No.: PCT/EP2014/056952

§ 371 Date: Oct. 7, 2016

(51) Int. Cl. F16H 25/24; F16H 55/08

(52) U.S. Cl. CPC F16H 25/24; F16H 55/08; F16H 2025/2481; F16H 2025/249

(57) ABSTRACT

The invention relates to a lead screw drive (10) and a spindle nut (12) for converting a rotational movement into a longitudinal movement or vice versa, wherein the internal thread (20) of the spindle nut and the external thread (30) of the spindle are of asymmetrical configuration with respect to one another. At least the internal thread (20) of the spindle nut or the entire spindle nut (12) is manufactured from plastic. The external thread (30) of the spindle has a higher strength. It is provided according to the invention that the internal thread (20) of the spindle nut (12) has a thread cross section, in which that profile section face (S1) of the thread spiral (21) which is intended for engagement into the thread (32) of the spindle (11) is greater, in particular is greater by a factor of at least 1.2, than the free thread section face (S2) of the thread (22) of the spindle nut (12).

The invention generally concerns a lead screw drive or lead screw actuator for converting a rotational movement into a longitudinal movement or vice-versa. The invention concerns in particular a lead screw drive having a spindle and a spindle nut, wherein at least the female thread of the spindle nut or preferably the entire spindle nut is made from plastic and the male thread of the spindle is of higher strength than the female thread of plastic.

In relation to screw drives a distinction is made between rolling screw drives like for example ball screw drives with balls as rolling members, and so-called conventional lead screw drives. The present invention concerns lead screw drives. It is known in relation to such lead screw drives to use a spindle nut of plastic on a spindle of high strength, for example consisting of steel. Such a lead screw drive is known for example from laid-open application DE 2300851.

Lead screw drives with spindle nuts of plastic afford in particular the advantage that they can be operated in very low-maintenance fashion, in particular in lubricant-free fashion.

EP 2 581 209 A1 describes such a lead screw drive, specifically for driving a press piston, in which the female and male threads are of an asymmetrical configuration relative to each other, that is to say they involve different geometries. In the spindle drive in accordance with EP 2 581 209 A1 the flanks of the female thread of the spindle nut are not mirror-image symmetrical with respect to a radial plane, but are of an asymmetrical configuration. In that case a return flank is of a markedly shallower angle relative to the working flank whereby the spindle nut can carry higher forces in a drive direction as the thread experiences better support at the tooth root of the spindle nut. That configuration provides that, even in the case of high loadings where hitherto steel was usually necessary as the material for the spindle nut, it is possible to use plastic as the material for the spindle nut. In consideration of that aim EP 2 581 209 A1 is viewed as the most relevant state of the art.

Taking the above-mentioned state of the art as the basic starting point an object of the present invention is to propose a lead screw drive having a spindle nut which is made completely or at least in the region of its female thread of plastic, which affords a longer service life and which is suitable for a larger number of uses. The invention also seeks to provide a correspondingly suitable spindle nut for such a lead screw drive.

The above-mentioned object is attained independently of each other by a lead screw drive as set forth in claim 1 and a spindle nut for such a lead screw drive as set forth in claim 11.

In the simplest embodiment the object is already attained in that the female thread of the spindle nut has a thread cross-section such that the profile sectional area of the thread helix, that is intended for engagement into the thread of the spindle, is measurably greater than the free thread sectional area of the thread of the spindle nut. In that respect the sectional areas are cross-sectional areas considered in a longitudinal section through the central longitudinal axis of the spindle nut and the spindle respectively, which corresponds to the schematized profile section. The profile sectional area denotes the sectional area, considered in that plane, of the thread helix or tooth arrangement of the spindle nut, measured between a line parallel to the longitudinal axis at the thread root and the apex or apex point. The thread sectional area denotes the correspondingly considered free area of the thread of the spindle nut thread, into which the thread helix or tooth arrangement of the male thread of the spindle engages.

In a preferred configuration the profile sectional area of the female thread of the spindle nut is greater by a factor of at least 1.2 than the free thread sectional area of the female thread. The thread sectional area denotes the free area of the thread. In the present case, the term thread is used to denote the recess of the thread or the thread groove and not for example the thread helix or tooth configuration.

In a particularly preferred embodiment it is provided that the positive profile sectional area is of a surface area which is in the region of between 1.2 times and 2 times, particularly preferably in the region of between 1.25 times and 1.4 times, the corresponding surface area of the thread sectional area. In that way production is possible even with spindle nuts made from plastic at least in the region of the female thread, with a long service life and at the same time a considerable permissible axial load. A difference in size in accordance with the invention can be readily implemented in practice insofar as the basic starting point adopted is a conventional configuration of a spindle drive with symmetrical tooth configuration and in regard to the spindle for example the thread helix is made about 10-35% narrower and the thread is made about 10-35% wider, than in the symmetrical configuration. A corresponding reversal is to be adopted in the configuration of the spindle nut.

To increase the possible uses it is advantageous if the oppositely disposed flanks in the profile section (in the profile sketch) of the female thread of the spindle nut are of a mirror-image symmetrical configuration with regard to a radial plane (perpendicularly to the longitudinal axis). Particularly preferably there is provided a flank angle which is quite large for motion threads, in the region of between 30° and 70°, in particular in the region of between 45° and 70°. In that respect the term flank angle is used to denote the angle of a thread flank relative to the oppositely disposed thread flank. Suitably optimized flank angles make it possible to achieve a higher level of efficiency, in which respect at the same time high loadings can be achieved in both directions of translatory movement, that is to say independently of the rotational direction.

To avoid vibration and unwanted noise generation it is advantageous if the transitions from flank to thread apex and from flank to thread root are rounded. That applies in particular for the female thread of the spindle nut, but advantageously also for the male thread of the spindle.

With suitably rounded transitions on the spindle nut it is advantageous if the nut has a thread cross-section whose thread apexes between the two flanks of a thread helix are rounded throughout. Thus, instead of the usual surface contact, it is possible to achieve a point contact in respect of the thread apexes, which also has a vibration-reducing and noise-reducing effect. In practice it is advantageous, at least for the thread apexes of the spindle nut, to achieve a rounding radius in the region of between 0.1 times and 0.5 times the value of the quotient of the thread pitch divided by the number n of threads (n>1 in the case of multi-thread spindles). A continuous rounding can also be provided on the male thread of the spindle, in which case here however by virtue of the markedly narrower thread root, a curvature radius which is reduced by a factor as correspondingly referred to above is also desirable.

In the case of a correspondingly rounded tooth geometry it is advantageous if the spindle nut has a female thread with a thread depth which is less than the thread depth of the male thread on the spindle. In that way it is possible to provide that, even in the case of unwanted inclined running only a minimal contact (point contact in the longitudinal section) occurs between the thread apexes of the male thread and the bottom of the thread groove (groove bottom) on the spindle core. Contact between the thread apexes of the female thread and the groove bottom on the core of the male thread does not at any event occur in that situation, not even in the event of unwanted transverse loadings or deformation.

Desirably the spindle nut is made from a technical plastic. Particularly preferably the spindle nut is made from a technical plastic, in particular an injection moldable, preferably lubricant-free, heavy-duty polymer, in particular with filling and/or reinforcing substances to improve fatigue strength and to reduce the coefficient of friction. In a particularly preferred embodiment the spindle nut is produced as a one-piece component. That can be effected for example preferably in one working operation completely using an injection molding process, that is to say the spindle nut is molded completely with the nut thread, or however by cutting machine of a blank which is produced by molding or extrusion. Optionally, in both cases cutting or machining post-processing can be performed in the region of the female thread, for example by turning down or turning out. Production in the form of two half-shells which are subsequently fitted together is also conceivable and is easier to implement in injection molding technology. A one-piece spindle nut however achieves a high level of precision in comparison without involving special measures.

Preferred embodiments are multi-thread in order to increase the load-bearing capacity. By virtue of one-piece production from plastic, it is technically possible with a relatively low level of complication and expenditure to produce spindle nuts having a three-thread, four-thread, five-thread etc up to a high number of threads, for example a twenty-thread female thread.

The proposed spindle nut and the proposed lead screw drive is suitable in particular for conversion in the region of between 1:10 and 2:1. Correspondingly, female and male threads are desirably produced with nominal diameters (=outside diameter in the case of the male thread) in the region of 3-30 mm and pitches in the region of 1-200 mm, in particular 2.5-100 mm. In this connection it is to be noted that by virtue of the differing dimension, the flank diameter is not at the level at which the thread groove and the thread tooth are of the same width. In simplified terms, the average value between core diameter and nominal diameter can be used as the flank diameter for calculating the pitch.

The spindle per se can be a pure metallic spindle, for example made from a stainless Cr—Mi-steel or aluminum. However a pure plastic spindle is also in accordance with the invention, in particular a spindle comprising a plastic of higher strength than the plastic of the female thread of the spindle nut or the spindle nut overall. It is also in accordance with the invention to provide a plastic or metal spindle with a suitable coating, for example for improving wear resistance and/or for optimizing frictional values. Irrespective of the lead screw drive overall the invention also concerns a spindle nut per se having the above-specified features. It can be for example in the form of a flange thread nut.

Finally the invention also concerns the use of such a spindle nut in a lead screw drive. Typical areas of use of the invention are areas in which freedom from lubricant is particularly advantageous or desirable, for example in clean room or medical technology. The lead screw drive according to the invention and the corresponding spindle nut however are suitable for a large number of other areas of use, for example in automobile engineering, automation installations and so forth.

Further details and advantages of the invention will be apparent hereinafter, without limitation on the scope of protection, from the description of a preferred embodiment with reference to the accompanying drawings in which:

FIG. 1 shows a diagrammatic perspective view of a portion of a lead screw drive according to an embodiment of the invention,

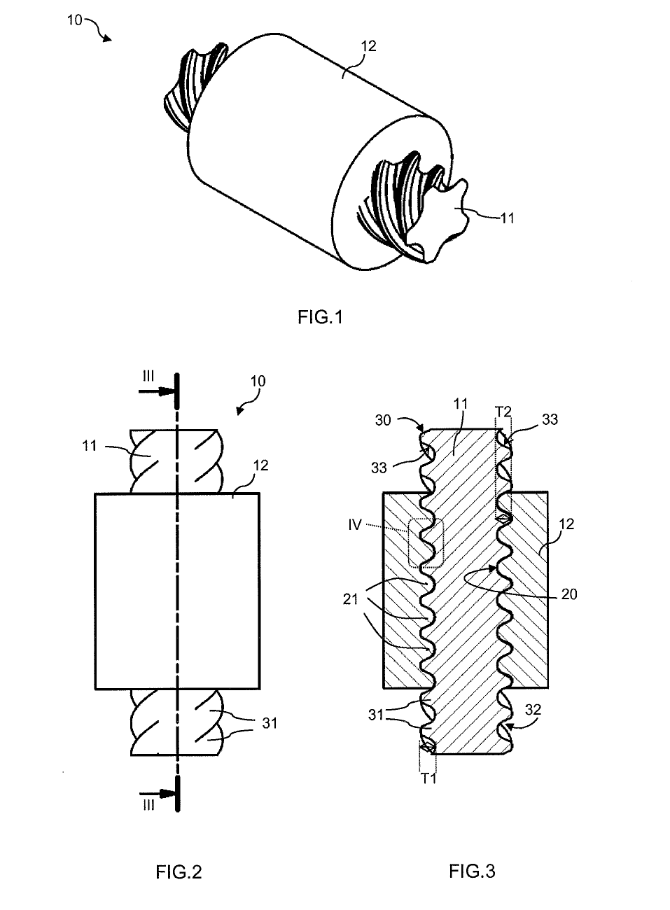

FIG. 2 shows a side view of the lead screw drive of FIG. 1,

FIG. 3 shows a longitudinal section on the main axis of the spindle and the spindle nut of the lead screw drive along section line III-III in FIG. 2, and

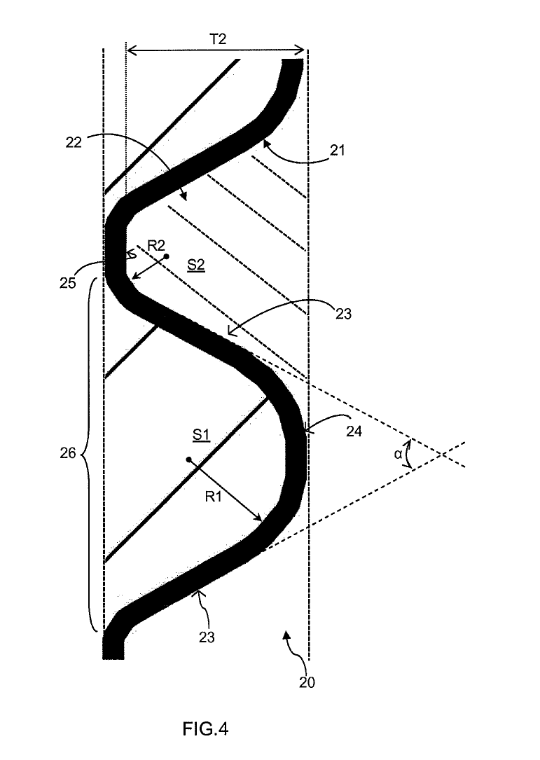

FIG. 4 shows a thread cross-section of the spindle nut corresponding to the enlarged portion IV in FIG. 3.

FIGS. 1 through 4 show a lead screw drive for conversion of a rotation of a spindle 11 into a longitudinal movement of a spindle nut 12. The spindle nut 12 is made in one piece from plastic by injection molding. The spindle nut 12 comprises a high-duty polymer, in particular with filling and/or reinforcing substances to achieve lubricant-free and low-friction operation. The spindle 11 comprises stainless Cr—Ni-steel which is of higher strength in comparison with the technical plastic of the spindle nut 12. The male thread 30 of the spindle 11 is for example a five-thread configuration, that is to say it has five thread helices 31. The female thread 20 of the spindle nut 12 also correspondingly has five thread helices 31 of the spindle also rounded throughout at the apexes thereof with approximately the radius R2.

As can best be seen from FIGS. 3 and 4 the female thread 20 and the male thread 30 are of an asymmetrical configuration relative to each other for the thread helices 21 of the spindle nut 12 are of markedly greater dimensions than the thread helices 31 of the spindle 11. The thread groove or the thread 21 of the female thread 20 and the thread 22 of the male thread 30 behave in correspondingly conjugated or complementary fashion for the thread helices 21 of the spindle nut 12 are in engagement with the threads 32 of the spindle 11 and vice-versa.

As can be seen in greater detail from FIG. 4, an enlargement of the thread cross-section of the female thread 20 of the spindle nut 12, the female thread 20 has a thread cross-section in which the profile sectional area S1 (coarsely hatched) of the thread helices 21 is greater by a factor of here about between 1.28 and 1.32 than the free thread sectional area S2 (finely hatched) of the thread 22, that is to say the thread groove of the spindle nut 12. Thus in this example the quotient S1/S2 complies with the inequality: 1.28≦S1/S2≦1.32 (in which case depending on the structural size in the specification a measurement or production tolerance of in the region of about 1-5% can be assumed).

The profile sectional area S1 and the thread sectional area S2 in this case are the areas measured in the profile section in FIG. 4 between the dotted parallel lines relative to the longitudinal axis, wherein one parallel (at the left in FIG. 1) extends through the thread root 26 or forms a tangent to the groove bottoms 25 and the other parallel forms a tangent to the apexes 24.

On the basis of the perceptibly larger size of the thread helices 21 of the spindle nut 12 in comparison with the thread helices 31 of the spindle 11 a markedly higher axial load can be carried with a plastic of the same strength, or a plastic can be used, where hitherto spindle nuts of metal were necessary. That effect is enhances synergistically, particularly in the case of large thread pitches, in that multi-thread female threads, in FIGS. 1 through 4 for example a five-thread female thread 20, can be markedly easily manufactured with plastic, in particular using injection molding, or can possibly only be produced at all in that way.

As can be seen from FIG. 4 in the case of the spindle nut 12 the transitions from flank 23 to thread apex 24 and from flank 23 to groove bottom 25 are rounded for reducing vibration. The thread apex 24 is preferably rounded throughout between the flanks 23 (being circular in the profile section), preferably with a rounding radius R1, for example about R1 ≈1.6 mm in the case of a five-thread thread with a 25 mm pitch (and a 6.35 mm nominal diameter), that is to say R1 corresponds to 0.32 times the value of ⅕ of the thread pitch (corresponding to a 5 mm axial structural length of the thread helix plus the thread). The transition from each flank 23 to the groove bottom 25 is also rounded with a rounding radius R2, wherein R2<<R1. In corresponding fashion, the profile section of the spindle 11 is preferably also provided with rounded configurations at both transitions. Accordingly a particularly preferred embodiment is one with a profile similar to a round thread, that is to say entirely without edges.

In principle in operation only the helical surfaces of the flanks 23, 33 run slidingly against each other. In order, in the event of unwanted inclined operation or damage, to avoid contact at both sides or a natural vibration resulting therefrom, the thread depth T1 of a male thread 30 of the spindle 11 is slightly greater than the thread depth T2 of the female thread 20 of the spindle nut 12. Thus a helical line contact occurs at the greatest between the apexes at the male thread 30 and the respective groove bottom 25 of the female thread 20.

The oppositely disposed flanks 23, 33 in the case of the female thread 20 and in the case of the male thread 30 are respectively of a mirror-image symmetrical configuration with respect to a notional radial plane through the profile section in FIGS. 3-4. They include a flank angle α which is unusually large for motion-producing threads, in the example shown in FIGS. 1-4 being about 50-60°. By virtue of the plastic properties and the good load-bearing capability of the thread helices 21 of the female thread 20 it is possible to implement such large flank angles α.

It remains to be noted that the spindle nut 12, unlike that shown in FIGS. 1-3, can be in particular in the form of a flange thread nut.

Lead screw drive with asymmetrical internal and external thread and corresponding spindle nut

### LIST OF REFERENCES

FIGS. 1 through 4:
10 lead screw drive
11 spindle
12 spindle nut
20 female thread or nut thread
21 thread helix (female thread)
22 thread (female thread)
23 flank
24 apex
25 groove bottom
26 thread root
30 male thread or spindle thread
31 thread helix (male thread)
32 thread (male thread)
33 flank
α flank angle
R1 radius (at the apex)
R2 radius (at the thread bottom)
S1 profile sectional area
S2 thread sectional area
T1 thread depth (spindle)
T2 thread depth (spindle nut)

1-20. (canceled)

21. A lead screw drive for converting a rotational movement into a longitudinal movement or vice-versa, comprising a spindle and a spindle nut;
wherein at least the female thread of the spindle nut or the entire spindle nut is made from plastic and the male thread of the spindle is of higher strength than the female thread;
wherein the female thread and the male thread are of an asymmetrical configuration relative to each other;
wherein the female thread of the spindle nut has a thread cross-section in which the profile sectional area of the thread helix, that is intended for engagement into the thread of the spindle, is greater, in particular by a factor of at least 1.2, than the free thread sectional area of the thread of the spindle nut;
wherein the transitions from the flank to the thread apex are rounded; and
wherein the spindle nut has a thread cross-section whose thread apexes are continuously rounded between the flanks to achieve a point contact of the thread apexes.

22. A lead screw drive as set forth in claim 21 characterised in that the quotient of the profile sectional area to the thread sectional area is of a value in the region of between 1.2 and 2, in particular in the region of between 1.25 and 1.4.

23. A lead screw drive as set forth in claim 21 characterised in that the transitions from the flank to the groove bottom are rounded.

24. A lead screw drive as set forth in claim 21 characterised in that the thread apexes are continuously rounded between the flanks corresponding to a rounding radius in the region of between 0.1 times and 0.5 times the value of the quotient of the thread pitch and the number of threads.

25. A lead screw drive as set forth in claim 24 characterised in that the thread depth of the female thread of the spindle nut is less than the thread depth of the male thread of the spindle.

26. A lead screw drive as set forth in claim 21 characterised in that the spindle nut is produced in one piece, in particular completely using an injection molding process or by cutting machining of a one-piece blank.

27. A lead screw drive as set forth in claim 25 characterised in that the spindle nut comprises an injection moldable and lubricant-free high-duty polymer, in particular with filling and/or reinforcing substances.

28. A lead screw drive as set forth in claim 1, characterised in that the oppositely disposed flanks are of mirror-image symmetrical configuration with a flank angle (α) for motion threads, in particular in the region of between 30° and 70°.

29. A lead screw drive as set forth in claim 21 characterised in that the spindle nut and the spindle are of a multi-thread configuration, with more than two and up to twenty thread helices, with a nominal diameter and pitch for conversion in the region of between 1:10 and 2:1.

30. A lead screw drive as set forth in claim 21, characterised in that the spindle is made
completely from plastic;
completely from metal, in particular a stainless Cr—Ni-steel or aluminum; or
from plastic or metal with a coating, in particular a metallic wear-resistant coating, at least on the male thread.

31. A spindle nut for a lead screw drive as set forth in claim 21,
wherein at least the female thread of the spindle nut or the entire spindle nut is made from plastic; and has an asymmetrical thread cross-section;
wherein the female thread of the spindle nut has a thread cross-section in which the profile sectional area of the thread helix, that is intended for engagement into the thread of the spindle, is greater, in particular by a factor of at least 1.2, than the free thread sectional area of the thread of the spindle nut;
wherein the transitions from the flank to the thread apex are rounded; and
wherein the spindle nut has a thread cross-section whose thread apexes are continuously rounded between the flanks to achieve a point contact of the thread apexes.

32. A spindle nut as set forth in claim 31 characterised in that the quotient of the profile sectional area to the thread sectional area is of a value in the region of between 1.2 and 2, in particular in the region of between 1.25 and 1.4.

33. A spindle nut as set forth in claim 31, characterised in that the transitions from the flank to the groove bottom are rounded.

34. A spindle nut as set forth in claim 33 characterised in that the thread apex is continuously rounded between the flanks corresponding to a rounding radius in the region of between 0.1 times and 0.5 times the value of the quotient of the thread pitch and the number of threads.

35. A spindle nut as set forth in claim 31 characterised in that the spindle nut is produced in one piece, in particular completely using an injection molding process or by cutting machining of a molded or extruded one-piece blank.

36. A spindle nut as set forth in claim 35 characterised in that the spindle nut comprises an injection moldable and lubricant-free high-duty polymer, in particular with filling and/or reinforcing substances.

37. A spindle nut as set forth in claim 31 characterised in that the spindle nut is of a multi-thread configuration, in particular with a number of between 3 and 20 thread helices.

38. A spindle nut as set forth in claim 31 characterised in that the spindle nut has a nominal diameter and pitch for conversion in the region of between 1:10 and 2:1.

39. A spindle nut as set forth in claim 31, characterised in that the oppositely disposed flanks are of mirror-image symmetrical configuration with a flank angle (α) for motion threads, in particular in the region of between 30° and 70°.

40. A spindle nut as set forth in claim 31, characterised in that the spindle nut is in the form of a flange thread nut.
